(19) United States
(12) Patent Application Publication
(10) Pub. No.: US 2003/0061131 A1
(43) Pub. Date: Mar. 27, 2003

(54) Automated income tax system

(76) Inventor: William A. Parkan JR., Pearland, TX (US)

Correspondence Address: MORRISON & FOERSTER LLP, 1650 TYSONS BOULEVARD, SUITE 300, MCLEAN, VA, 22102, US

(21) Appl. No.: 09/957,075

(22) Filed: Sep. 21, 2001

(51) Int. Cl. G06F 17/60

(52) U.S. Cl. 705/30; 705/31

(57) ABSTRACT

Disclosed in a system and method for receiving, transforming, analyzing, storing, and reporting detailed tax and financial information in a computer-based tax information system. In the preferred embodiment, the present invention includes a central processing unit that includes a variety of engines. The engines perform the functions of transforming data, analyzing financial information, applying tax rules to arrive at adjustments and individual tax liabilities, data formatting and storage, and the preparation of detailed reports, forms, and schedules to expedite the preparation of documents for filing in accordance with compulsory regulations of institutions such as the Internal Revenue Service and Securities and Exchange Commission.

### FIELD OF THE INVENTION

The invention relates to a method for transforming, analyzing, storing, and reporting detailed tax and financial information. Described is a system and method for analyzing financial information, applying processing rules to the information, and thereby automatically generating highly detailed reports for use in financial transactions and to satisfy compulsory reporting requirements in situations such as filing income tax returns and for use in financial planning.

### BACKGROUND OF THE INVENTION

The United States Tax Code is a multi-volume compendium of ever-changing tax laws. Preparing tax returns, forms, and schedules that comply with the requirements of the Internal Revenue Service, banks, and other financial institutions is, at best, at time consuming process made more difficult by the fact that the tax code is amended annually. Further, individuals and institutions alike spend a great deal of time and effort attempting to comply with the tax code, gather information for tax and audit planning, and prepare the documents required by various federal, state, and local agencies.

Adding to the problems associated with compliance to the Internal Revenue Code are the large number of state and local revenue reporting and taxation requirements. For many, as well, international tax and revenue reporting requirements can be a significant burden. Each of these schemes may include a significant number of rules and regulations that must be followed, varying tax rates that must be known precisely, specific reporting format requirements, and a significant number of calculations that must be performed. Further, due to the sheer volume of data that must be used and the variety of formats in which data may exist when collected, transforming and processing such data can add significantly to the already arduous task of preparing detailed financial statements and determining overall tax liabilities.

It would be desirable, therefore, to have a system and method for gathering and storing tax and financial information that can be conveniently formatted and output as a form, schedule, or report to be filed in accordance with a compulsory revenue reporting scheme.

Further, it would be advantageous to have a system and method for transforming a wide variety of data types into a single, common format that can be used by a plurality of calculation modules that are able to analyze data and generate data required according to compulsory reporting schemes and for use in financial planning.

Finally, it would also be advantageous to enable such a system for use by institutions and individuals via a distributed network such as the world wide web.

### SUMMARY OF THE INVENTION

The present invention relates to a method for processing financial data in which begins by receiving source data at a central processing unit; transforming the source data into a common format; storing the data in a storage unit; and applying financial rules to said data stored in said storage unit in at least one calculation engine.

In an alternate embodiment, the invention is a system for providing financial data analysis. The system includes, at least, a user terminal connected to a distributed network a central server connected to the distributed network that is in electronic communication with the user terminal; a data warehouse resident in the central server for storing financial information; and at least one calculation engine resident in the central server for analyzing and reporting said financial information in the data warehouse in response to a query received from said user terminal.

### BRIEF DESCRIPTION OF THE DRAWINGS

FIG. 1 A diagrammatical representation of the tax information system of the present invention.

FIG. 2 An illustration of the tax information system of the present invention with greater detail with respect to the calculation engine and source data.

FIG. 3 A depiction of the data flow for rules processing within the tax information system of the present invention.

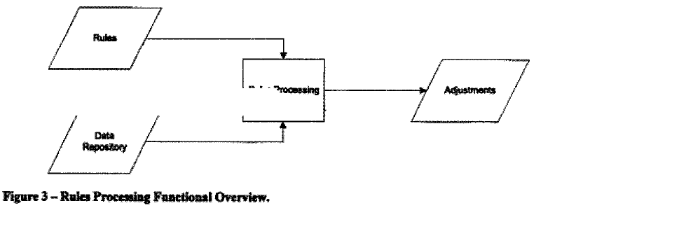

FIG. 4 A detailed illustration of the stages and transformations applied to source data prior to storage in the data repository.

FIG. 5 An illustration of an M Class code in accordance with the present invention.

FIG. 6 A depiction of the structure of a numerical M Class code.

FIG. 7 A diagrammatical representation of a structural example of an M Class code used in accordance with the present invention.

FIG. 8 A graphical illustration showing the numerical representation of detail levels associated with an M Class code.

FIG. 9 A graphical illustration of the data flow into and out of the provision calculation engine of the present invention.

FIG. 10 A diagrammatical representation of the distributed network tax portal system of the present invention.

The invention will be better understood by reference to the Detailed Description of the Invention when taken together with the attached drawings, wherein:

### DETAILED DESCRIPTION OF INVENTION

In a preferred embodiment, the present invention is directed toward a system for creating a repository of financial and tax information. The data stored in the repository can include federal, state, and local tax rules, rules relating to Securities and Exchange Commission filings, and rules for preparing documents for filing with a wide variety of governmental and private financial institutions. In addition the present system can also store financial information for individuals, companies, or other institutions for the purpose of examining such data in accordance with the rules stored in the system. Based on the data stored, tax forms and other financial instruments can be prepared automatically.

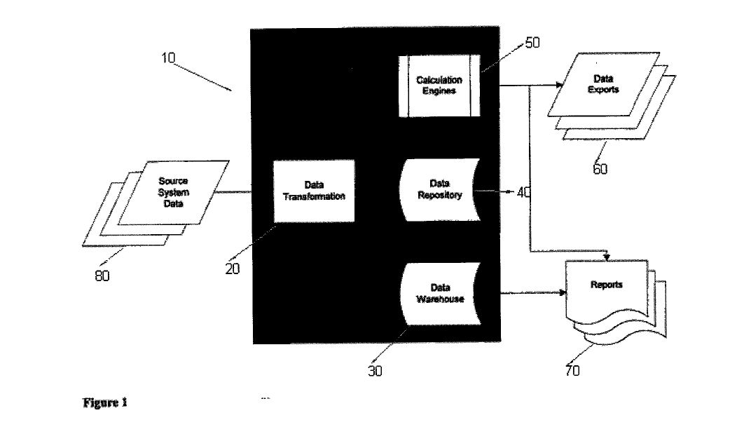

FIG. 1 depicts the block flow diagram of the present invention when used as a tax information system. Source system data 80 is sent to the data transformation engine 20 to be converted into a specific file format that is recognized by the various calculation engines and data repositories of the tax information system 10. The source system data 80 can include various sorts of financial information, tax rules, and reporting format guidelines. Once properly formatted, the data transformation engine 20 forwards the formatted data to the data repository 40 where it is stored until the calculation engines 50 or the data warehouse 30 requests the data for further processing.

The calculation engines 50 may request data from the data repository 40 to process the data and apply rules thereto to generate additional data that may contain summaries or more detailed analysis of the data stored in the data repository 40 such as earnings and profits calculations, stock basis calculations, tax basis balances, and other financial information relating to state and federal taxes, etc. After processing the data received from the data repository 40, the calculation engines 50 may provide exported data 60 or a formatted report 70 for further use. In instances where no calculations need to be performed and no analysis of the data is necessary, the data warehouse 30 will receive data from the data repository 40 and prepare a formatted report 70 for further use.

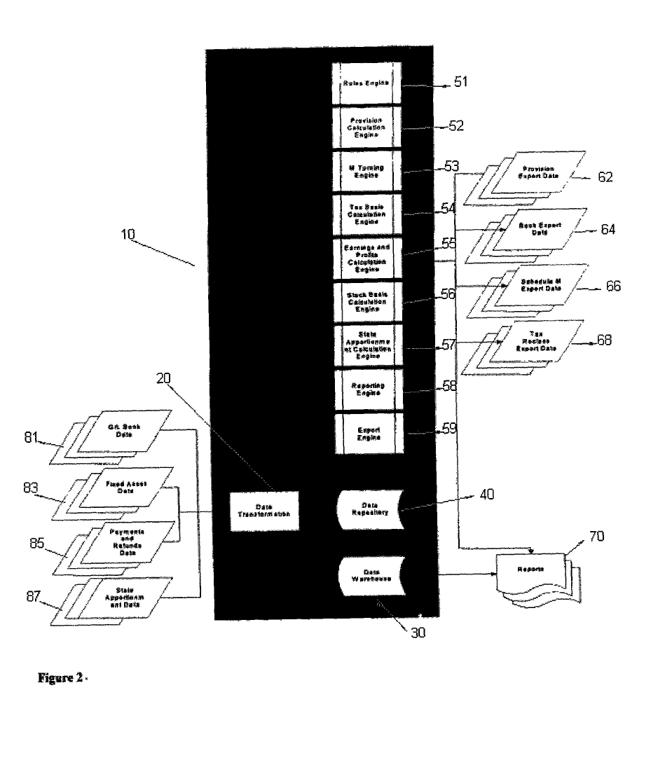

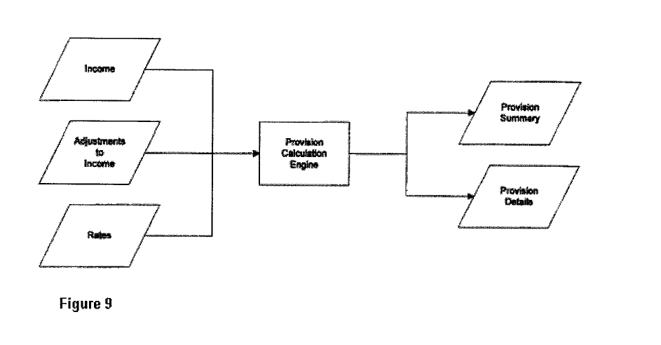

FIG. 2 illustrates the tax information system 10 of the present invention in greater detail. The source system data 80 that is sent to the data transformation engine 20 can be in a variety of formats. For example, the data transformation engine receive general ledger book data 81, fixed asset data 83, payment and refunds data 85, and state apportionment data 87. There are representative but not exclusive of the types of data that can be fed to the data transformation engine to be converted into the format recognized by the data repository 40, the data warehouse 30 and the calculation engines 50. The data converted by the data transformation engine 20 is stored in the data repository 40 for further processing in the calculation engines 50 and the data warehouse 30. The calculation engines 50 can include a wide variety of sub-engines capable of transforming the data stored in the data repository 40 for various purposes. For example, the calculation engines 50 may include a rules engine 51. The rules engine 51 can apply rules against data stored in the data repository to create adjustments. The rules engine determines what data to extract from the data repository and what treatment to apply for the adjustments that are created. The rules applied by the rules engine 51 can be defined to extract an amount from a specific account or range of accounts for general ledger data either for a specific entity or a range of entities. Further, an amount can be extracted from a particular type of asset for one or more entities. Once data from the data repository 40 has been processed for adjustments by the rules engines 51, the data may be sent to a provision calculation engine 52. The provision calculation engine 52 processes data from the data repository 40 to create summary-level information for provision reporting purposes and to create detailed-level taxes for booking-back to the general ledger. The provision calculates both a total domestic provision and a total foreign provision. The processing of the provision combines income, reversals of prior month taxes, temporary differences, permanent differences, other tax provision adjustments, other tax liability adjustments, and tax credits to calculate both current and deferred taxes. A block flow diagram illustrating the flow of data through the provision calculation engine 52 is shown in FIG. 9.

In one embodiment, the provision calculation engine 52 calculates the foreign provision starting with net income after tax and factors-in prior period deferred state taxes, prior period current state taxes, prior period current federal taxes and prior period current foreign taxes to reach a net-income-before-taxes value. Temporary and permanent Schedule M's are then layered on top to reach a foreign taxable income value. The foreign jurisdiction rate is applied to the foreign taxable income to reach the current foreign taxes. Other foreign adjustments and tax credits are applied to the current foreign taxes to determine the total current foreign income tax. Deferred foreign taxes are calculated using the foreign temporary Schedule M's and the foreign jurisdiction rate. Other deferred foreign adjustments and deferred tax credits are applied to the deferred foreign taxes to reach the total deferred foreign taxes. Further, the sum of the total current taxes and the total deferred taxes is used to determine the total foreign income tax. Net income and loss for foreign income tax and a computed effective tax rate are also calculated.

Calculating the total domestic provision starts with net income tax after tax and factors-in prior period deferred state taxes, prior period current state taxes, prior period current federal taxes, and prior period current foreign taxes to reach a net income before taxes value. Temporary and permanent Schedule M's are then layered on top to reach a state taxable income value. Current state tax expenses and benefits, including other adjustments, are calculated using the current foreign income taxes combined with the state tax income value to get a federal taxable income or loss value. Current federal income taxes are calculated using the federal taxable income and federal tax rates. Current state income taxes are calculated using the state income tax rates. Current foreign income tax, other federal adjustments, other state adjustments, and tax credits are combined with the federal and state taxes to reach the total current tax expense or benefit. Deferred state income tax is calculated using the state rates and temporary adjustments. Deferred foreign income tax is combined with the deferred state taxes, temporary adjustments, and the federal rate to calculate the deferred federal income tax. Other deferred federal adjustments and other deferred state adjustments and deferred tax credits are combined with the deferred federal, state, and foreign taxes to calculate the total deferred tax expense or benefit. The total tax expense or benefit is then calculated using the total current tax expense and the total deferred tax expense or benefit. Computed effective rates are also calculated.

The present system may include sub-engines within the provision calculation engine 52 or additional engines for data processed by the provision calculation engine 52, such as an M turning engine 53, a tax-basis calculation engine 54, an earnings and profits calculation engine 55, a stock-basis calculation engine 56, and a state apportionment calculation engine 57. All of other engines may forward processed data to either a reporting engine 58 or an export engine 59 or both. The export engine 59 can receive data from any of the previously mentioned engines and format it for export as either provision export data 62, book export data 64, schedule M export data 66 or tax re-class data 68. Other exported formats for data can be used depending on the nature of the processing to be done to the exported data. For example, exported data can be in a format which can be read and further processed by personal income tax preparation and reporting software used on personal computers.

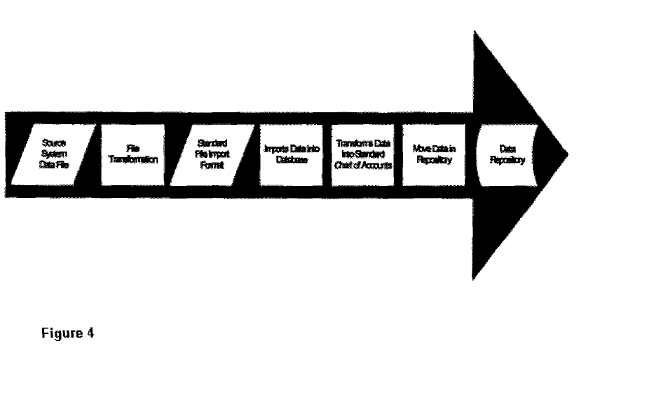

FIG. 4 illustrates a more detailed flow diagram of data received by the data transformation engine 20, how it is processed, and how it is forwarded to the data repository 40. As shown in FIG. 4, a source system data file 21 under goes a file transformation process 22 which results in standard file import format 23 that can be understood by the various calculation and rules engines of the tax information system 10. The standard file import format 23 undergoes importation into a database 24, transformation of data into standard charts of accounts 25, and moving into a data repository 26 until the transformed data is finally stored in data repository 40. As the data flows through the data transformation engine, it is validated, transformed, and then placed in the proper location within the data repository noting that different data types are stored in specific locations in the data repository. The data transformation engine supports many data sources, many data source prefixes, multiple load types, export treatments, multiple charts of accounts, reverse sign ranges, default account ranges, multiple charts of accounts, multiple charts of entities, and multiple charts of jurisdictions.

A data source is any source containing data that can be stored in the tax information system data repository. A data source can be a database, an Excel® Spreadsheet, and ASCII text file, etc. When a data source is defined in the tax information system, a unique data source ID is created. The data souce id is a unique number that identifies the data source. Once the id has been defined, additional information associated with a data source can be associated with the data source using the unique data identifier. The additional data may include the data source description, the chart of entities, the chart of jurisdictions, the data source prefix or suffix, each entity that is sent from the data source, and the chart of accounts each entity uses. For example, two entities from the same data source can use two different charts of accounts. An unlimited number of data sources can be defined according to the present system. The chart of entities created by the data transformation engine 20 is a list of entities and transformation rules that are applied when an entity moves through the data transformation engine. The data transformation rules include the entity number that the source system entity number should be transformed to. When a chart of entities is defined in the tax information system 10, a unique chart of identity IDs is created. An unlimited number of charts of identities can be defined.

The chart of jurisdictions is a list of jurisdictions and transformation rules that are applied when a jurisdiction moves through the data transformation engine. The transformation rules include the jurisdiction code that the source system jurisdiction code should be transformed into. When a new chart of jurisdictions is defined in the tax information system 10, a unique chart of jurisdiction IDs is created. An unlimited number of chart of jurisdictions can be defined. By associating a chart of entities and a chart of jurisdictions with a specific data source, the entities and jurisdictions being sent from that data source will be transformed based on the rules defined for that chart of entities and chart of jurisdictions. The data source prefix and suffix identifies characters that will be used in the name of the file that is being sent to the tax information system 10 from the source systems.

The load type defines the type of data that will be contained in a particular data file. The data might be general ledge book data, fixed asset data, payments and refunds data, or state apportionment data, although this list is not necessarily exclusive. When a new load type is defined, a unique load type ID is created. Additional information that is associated with the load type is the load type description, the export treatment, and the load-type prefix. The export treatment defines where in the data repository 40 the data should be placed. The data might be general ledge data for the provision, fixed asset for the provision, payment and refund data, state apportionment data, etc. Each type of data needs to be placed in a particular location in the data repository. The load type prefix is the prefix that will be on the file when it is generated from the source system. This information is used to help pick-up the correct file and process it in a timely manner.

A chart of accounts defines the source system account numbers, account descriptions, and transformation rules that are applied when an account moves through the data transformation engine. The transformation rules include the account number that the source system account number should be transformed to. When a new chart of accounts is defined in the tax information system, a unique chart of account IDs is created. The tax information system 10 supports an unlimited number of charts of accounts. By unlimited, it is understood that the tax information system 10 may accommodate any number of items limited only by the physical storage space available to the user. In the absence of any limitation of storage space, the ability of the tax information system 10 to accommodate an unlimited number of charts, IDs, etc. exists.

Reverse sign information and default account range information is defined for each chart of accounts. The reverse sign translation information allows for the plus/minus signs to be reversed for multiple ranges of accounts. If a range of accounts is being received with a negative sign, and the range of accounts is expected to have a positive sign, the reverse sign transformation information can address this. The default account range information allows for new accounts to be defaulted as they flow through the data transformation engine. If a new account was created in the general ledger and not inside of the tax information system 10, then the new account would be defined automatically as long as the ranges of default accounts was set up and the account fell within one of the ranges. Additionally, the data transformation engine 20 may default the creation and translation of new divisions, default the creation and translation of new accounts, create working logs and error reports for data formats that cannot be interpreted, consolidate data for one division across multiple data sources, translate jurisdiction codes, and track the last amount to be imported from a source system data file and the last amount to be exported to the data repository at a transactional level. Further, the data transformation may support drill-down for the data repository to the original imported data or pass information through the data transformation engine 20 without translation. Drill-down is the ability to view an account balance value and then “drill-down” (into the various data repositories) and be able to view the information that was combined to create the account balance or other summary information. Drilling-down gives the ability to see high level summary information and also the detailed information that was combined to create the summary level information.

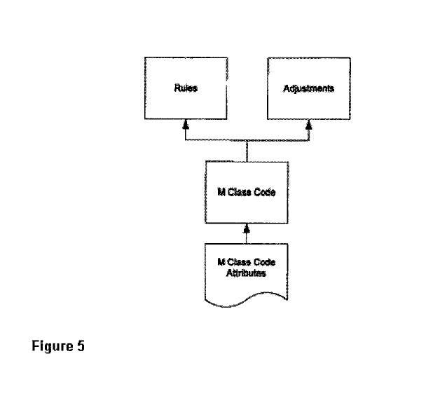

The M class codes that are used in the tax information system 10 define attributes of an adjustment or a rule. Adjustments are used throughout the tax information system 10 to capture financial and tax-related information. The M class codes contain the following numerically delineated attributes: M class code description, percent disallowed, adjustment type, adjustment sub-type, five multi-purpose fields, and an M account. M class codes are associated with rules and adjustments. Once an M class code is associated with a rule or adjustment, the rule or adjustment inherits the attributes associated with the M class code. FIG. 5 shows diagrammatically the process by which M class code attributes are applied toward rules and adjustments.

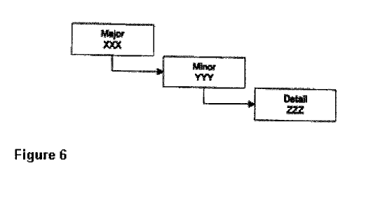

Specifically, the M class code is a nine-digit character string that is broken up into three three-digit parts. These three-digit parts are defined as a major, minor, and detailed part. The major, minor, and detailed breakdown is shown in FIG. 6. The present invention, in the preferred embodiment, uses nine-digit M class codes, those of ordinary skill in the art will recognize the M class codes of any number of digits can be used provide they convey the necessary information to correctly apply attributes to rules and adjustments.

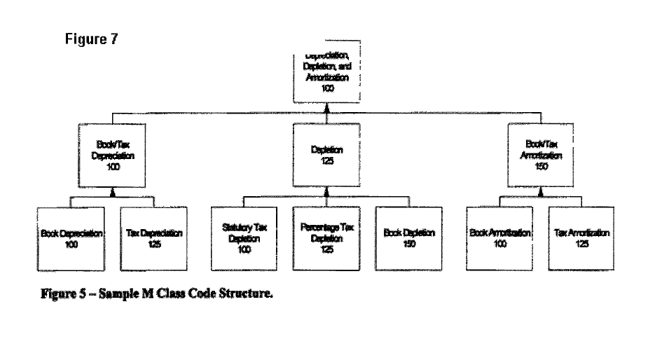

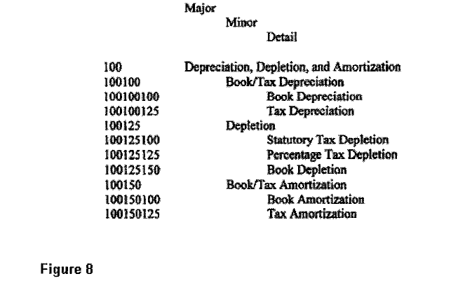

An example of the M class code is its use for generating the correct attributes of a rule or adjustment that is applied to a depreciation, a depletion or an amortization. The categories of depreciation, depletion and amortization can be broken up into three parts consisting of book/tax depreciation, depletion, and book/tax amortization. Each of these three categories can be broken up into additional pieces. Book/tax depreciation can be broken up into book depreciation and tax depreciation. Depletion can be broken up into three parts, statutory tax depletion, percentage tax depletion, and book depletion. Amortization can be broken up into the two parts of book amortization and tax amortization. The resulting M class code structure is shown diagrammatically in FIG. 7. Detail of the M class code itself is shown in FIG. 8.

Reports can be generated based on the M class code to provide various levels of detail. Summary-level reporting can be done at the major level (100 as shown in FIGS. 7 and 8) which include depreciation, depletion, and amortization. More detailed reporting may be required and, therefore, the minor level can be used which is shown in FIGS. 7 and 8 as book depreciation and tax depreciation. An additional level of reporting can be obtained through the use of the detail-level of the M code which may include book amortization and tax amortization individually. Other detail-level reports could include statutory tax depletion, percentage tax depletion, or various levels of book and tax depreciation.

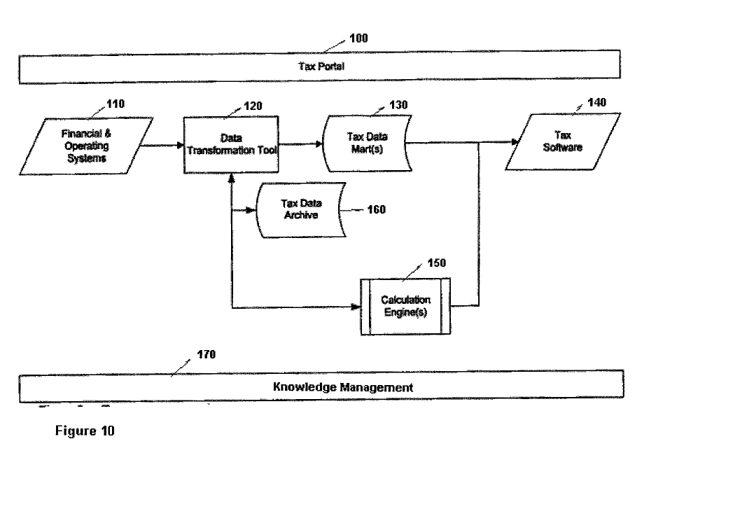

In another embodiment of the invention as shown in FIG. 10, a computer-based solution that uses the tax information system to provide users having an interface to the World Wide Web or similar distributed network with a system and method whereby they may readily access tax and financial information. This embodiment also discloses the additional modules relating to a knowledge management tool and an audit planning tool.

With reference to FIG. 11, financial and operating system data 110 is passed to the data transformation tool 120. The data transformation tool operates in a manner similar to that previously described and further comprises mapping and analysis tools that allow the data transformation tool to map multiple charts of accounts into a single standardized chart. The data transformation tool 120 can also transform codes such as location codes into a single, standardized format. In this embodiment, the data transformation tool 120 uses client-specific data quality rules to check for missing fields, invalid values, etc. for each record imported. Further, the data transformation tool 120 is provided with an error correction feature wherein predefined rules for handling errors are included in the data transformation tool 120 that can automatically correct errors or bring them to the attention of users to review and correct manually. The transformed and corrected operating systems data is updated with any corrections found and may be further corrected by the error correction feature. As well, the data transformation tool 120 can convert financial and operating systems data into files that are readily recognized and loaded into a tax data-mart 130. A complete audit trail is produced by archiving data exactly as received from the source system, as transformed, and as corrected.

The tax data-mart 130 receives transformed data from the data transformation tool 120 allowing high speed access for ad hoc queries, data browsing, and data mining. The tax data-mart 130, in its simplest form, is a database containing transformed financial and operating systems data that can be queried and rapidly searched to provide data to be used in tax calculation and processing tools such as income tax reporting software, property tax reporting software, sales and use tax reporting software, and other client-specific applications such as enterprise-wide data analysis.

The tax data-mart 130 can be queried by a variety of tax software systems 140 wherein a user requests a particular type of data and a particular type of analysis to be performed on that data. In this instance, the user inputs their query to the tax software 140 and the query is sent to the tax data-mart 130. The tax data-mart 130 retrieves the appropriate data and sends it to the calculation engine 150 along with the instructions for the type of processing which must be performed. The calculation engine 150 includes a tax calculation tool that is essentially a rules manager containing automation rules that determine the treatment of an account or transaction. Other automation rules which are customized for each client instance, per-account/transaction basis, etc. may be used to supplement or override standard rules. Customized rules allow for clients with charts of accounts not based on the standard, or for special treatment of certain accounts in the standard chart of accounts.

The tax calculation tool includes calculation modules relating to provisions, estimated payments, tax basis, earning and profit calculations, stock basis, apportionment factors, and Schedule M turning. Once the data received from the tax data-mart 130 has been processed in accordance with the requests of the user, the calculation engine 150 forwards the results of the calculation to the data transformation tool 120 to be formatted and returned to the tax data-mart for storage and forwarded back to the user via the tax software 140. Additionally, a tax data archive 160 receives a copy of the data forwarded from the calculation engine to the tax data transformation tool 120. The tax data archive simply provides a way of storing complete sets of data transferred through the present system for storage on a secondary device as well as for permanent storage such as burning the data onto a CD-ROM. This provides a complete set of data to support audits and adhere with revenue procedure 98-25 where necessary.

The tax software 140 may be integral to the user's web browser, downloaded via the tax portal 100 and incorporated into the user's web browser as a JAVA applet or similar application, or be resident on the user's computer. When resident on the user's computer, the tax portal 100 permits an interface between the user's tax software 140 and the tax information system of the present embodiment. Regardless of the nature of the tax software 140, the tax portal 100 provides a secure method for the user to interface with the tax information system. In the preferred embodiment, the tax portal 100 is a secure web-based application that runs in a web browser. This provides the user the front-end for the tax information system and links users to various Internet sites, tax advisor sites and other locations on the World Wide Web, while allowing for automatic push distribution of reports to specific recipients via channels and electronic mail. The look and feel of the tax portal 100 can be customized and branded for different clients, and the various links may be customized as well.

The knowledge management tool 170 is an aspect of the tax portal 100 that allows for document management. The knowledge management tool 170 serves as a central repository of work paper files, research history, deal history, and reference material. The knowledge management tool 170 allows for full text searching capabilities of stored documents, imaged documents, and summarizes information for management reporting purposes. The knowledge management tool 170 can provide reports and responses to queries based on a variety of criteria, including communication by integrating related tax activities and reporting via e-mail or hard copy, allowing users and reviewers to review audit information, and due date/status tracking of the various forms and filings that must be made.

Not shown in FIG. 11 is the audit planning tool which can operate as an extension of the tax data-mart 130. The audit planning tool provides audit and planning calculations based on data stored within the tax data-mart 130. The various scenarios which could be supported by the audit planning tool are “T-by-T” analysis, credit/carryover analysis, FTC planning, merger and acquisition planning and restructuring, subpart F planning and Nexus planning. Finally, the tax portal 100 may also include capabilities for firm-wide data warehousing. A firm-wide data warehouse can hold quantitative and statistical data for all users of the tax information system as described herein. Such information may include client benchmarking, data mining for planning opportunity implementations, engagement management, and profitability analysis by client. Of course, this list is non-exclusive and any data submitted or requested by the client can be warehoused.

Those skilled in the art will recognize that the method of the invention has many applications, and that the invention is not limited to the representative embodiments disclosed herein. The scope of the invention is only limited by that of the claims appended hereto.

What is claimed is:

1. A method for processing financial data comprising:
receiving source data at a central processing unit;
transforming said source data into a common format;
storing said data in a storage unit; and
applying financial rules to said data stored in said storage unit in at least one calculation engine.

2. The method of claim 1 wherein said source data comprises general ledger book data.

3. The method of claim 1 wherein said source data comprises fixed asset data.

4. The method of claim 1 wherein said source data comprises payment and refund data.

5. The method of claim 1 wherein said source data comprises state apportionment data.

6. The method of claim 1 wherein said calculation engine comprises a rules engine.

7. The method of claim 1 wherein said calculation engine comprises a provision calculation engine

8. The method of claim 1 wherein said calculation engine comprises an M turning engine.

9. The method of claim 1 wherein said calculation engine comprises an M turning engine.

10. The method of claim 1 wherein said calculation engine comprises a tax basis calculation engine.

11. The method of claim 1 wherein said calculation engine comprises an earnings and profits calculation engine.

12. The method of claim 1 wherein said calculation engine comprises a stock basis calculation engine.

13. The method of claim 1 wherein said calculation engine comprises a state apportionment calculation engine.

14. The method of claim 1 wherein said calculation engine comprises a reporting engine.

15. The method of claim 1 wherein said calculation engine comprises an export engine.

16. The method of claim 15 wherein said export engine transforms analyzed financial data into provision export data.

17. The method of claim 15 wherein said export engine transforms analyzed financial data into book export data.

18. The method of claim 15 wherein said export engine transforms analyzed financial data into schedule M export data.

19. The method of claim 15 wherein said export engine transforms analyzed financial data into tax reclass export data.

20 A system for analyzing financial data comprising:
a central processing unit for receiving financial data;
a data transformation engine operating within said central processing unit for transforming said financial data into specifically formatted data;
a calculation engine for applying financial analysis rules to said specifically formatted data to generate tax liability data; and
a data warehouse for storing said specifically formatted data and said tax liability data.

21. The method of claim 20 wherein said source data comprises general ledger book data.

22. The method of claim 20 wherein said source data comprises fixed asset data.

23. The method of claim 20 wherein said source data comprises payment and refund data.

24. The method of claim 20 wherein said source data comprises state apportionment data.

24. The method of claim 20 wherein said calculation engine comprises a rules engine.

25. The method of claim 20 wherein said calculation engine comprises a provision calculation engine

26. The method of claim 20 wherein said calculation engine comprises an M turning engine.

27. The method of claim 20 wherein said calculation engine comprises an M turning engine.

28. The method of claim 20 wherein said calculation engine comprises a tax basis calculation engine.

29. The method of claim 20 wherein said calculation engine comprises an earnings and profits calculation engine.

30. The method of claim 20 wherein said calculation engine comprises a stock basis calculation engine.

31. The method of claim 20 wherein said calculation engine comprises a state apportionment calculation engine.

32. The method of claim 20 wherein said calculation engine comprises a reporting engine.

33. The method of claim 20 wherein said calculation engine comprises an export engine.

34. The method of claim 33 wherein said export engine transforms analyzed financial data into provision export data.

35. The method of claim 33 wherein said export engine transforms analyzed financial data into book export data.

36. The method of claim 33 wherein said export engine transforms analyzed financial data into schedule M export data.

37. The method of claim 33 wherein said export engine transforms analyzed financial data into tax reclass export data.

38. A system for providing financial data analysis comprising:
a user terminal connected to a distributed network;
a central server connected to said distributed network and in electronic communication with said user terminal;
a data warehouse resident in said central server for storing financial information;
at least one calculation engine resident in said central server for analyzing and reporting said financial information in said data warehouse in response to a query received from said user terminal.
